(19) United States
(12) Patent Application Publication
(10) Pub. No.: US 2016/0298875 A1
(43) Pub. Date: Oct. 13, 2016

(54) SURFACE STRUCTURE FOR SOLAR HEAT ABSORBERS AND METHOD FOR THE PRODUCTION THEREOF

(71) Applicant: COMMISSARIAT A L'ENERGIE ATOMIQUE ET AUX ENERGIES ALTERNATIVES, Paris (FR)

(72) Inventors: Olivier DELLEA, La Talaudière (FR); Emmanuel OLLIER, Grenoble (FR)

(73) Assignee: COMMISSARIAT A L'ENERGIE ATOMIQUE ET AUX ENERGIES ALTERNATIVES, Paris (FR)

(21) Appl. No.: 15/100,897

(22) PCT Filed: Nov. 28, 2014
(86) PCT No.: PCT/IB2014/066420

§ 371 Date: Jun. 1, 2016

(30) Foreign Application Priority Data
Dec. 4, 2013 (FR) 13 62104

(51) Int. Cl. F24J 2/04; F24J 2/48; B23K 26/00

(52) U.S. Cl. CPC F24J 2/0488; B23K 26/0084; F24J 2/481

(57) ABSTRACT

A textured surface for a solar heat absorber, includes a substrate in an optically reflective material having a reference surface and a group of textural elements distributed according to a two-dimensional arrangement along the reference surface. The elementary structure of a textural element includes a cavity formed in the substrate and a crown. The crown projects beyond the reference surface and is positioned directly on the periphery of the edge of the cavity.

The present invention relates to a textured surface structure for solar heat absorbers, capable of operating at high temperatures and to a method for producing such a structure.

Making a wavelength-selective surface treatment for solar heat absorbers is known in order to improve the conversion efficiency of solar radiation into heat.

The operating principle of a solar heat absorber is simple and consists for the solar absorber to absorb the energy coming from the sun for heating a liquid such as for example water or steam, circulating in contact with the absorber.

Two main quality requirements guide the design and the production of a solar heat absorber: that of efficiently absorbing the energy of the solar radiation and that of efficiently reflecting the infrared heat radiation of the absorber in order to avoid thermal losses and to tend to the making of a black body.

Several types of materials in thin layers have already been the subject of studies for this type of application such as for example black chromium, Ni—Al₂O₃, stainless steel, aluminium nitride (AlN), Mo—Al₂O₃, and Mo—AlN. Certain of these materials are even industrialized while being produced on a large scale. However, these materials ensuring this selectivity have shown their potential only up to 600° C., since beyond this temperature, the actual stability of the layer deposits is not guaranteed, or even is faulty.

For high temperatures, i.e. temperatures above or equal to 600° C., the materials W, Mo, Pt, Ni, Si are known to be more stable thermally. However these materials in the absence of texturation of their surface have no or very little selectivity, i.e. they have low absorption of the solar spectrum and low reflection in the field of the infrared. As described in the article of J. Wang et al., entitled <<Simulation of two-dimensional Mo photonic crystal for high-temperature solar-selective absorber>>Phys. Status Solidi A 2007, No. 8, 1988-1992 (2010), these planar refractory materials deviate from their reflection spectra from the ideal selectivity curve for solar heat absorbers, for which the threshold wavelength λₜₕ is close to 2 μm.

In order to increase the spectral selectivity of the heat absorber and to maintain its conversion efficiency at these temperatures, it is known how to structure or texture the surface of refractory materials in order to obtain the optical properties required for a selective heat absorber, i.e. an absorption of the solar electromagnetic radiation in the visible range of more than 95% and emissivity in the infrared (IR) of less than 5%.

Generally the applied surface structurations are made by using photonic crystals.

Within this scope, investigation studies, generally limited to studies for simulating the performances of certain surface structures in the field of solar heat absorbers, and very little concerned by the industrialization of the manufacturing of these structures, have considered various types of photonic crystals and have been published.

From among the photonic crystals, known to be periodic micro- or nano-structures which advantageously affect the propagation of electromagnetic waves, one-dimensional (1D), two-dimensional (2D) and three-dimensional (3D) forms have been studied, the dimensions representing the number of directions according to which there exists periodicity of the dielectric constant.

The investigated surface structures are relatively standard and comprise a matrix of circular or square holes, a matrix of pads, a matrix of pyramids, a succession of parallel grooves, crossed networks of beams.

When manufacturing methods are proposed for certain of these structures, the latter are complex to make and incompatible with large scale production.

For large scale production, it is necessary to be able to produce the obtained characteristic dimensions of the surface structure of the order of one micrometer or less without resorting to the use of standard photolithographic methods applying exposure of a photoresist or to writing with an electron beam.

The article of H. Saui et al., entitled <<Numerical study on tungsten selective radiators with various micro/nano structures>>, Photovoltaic Specialists Conference, 2005, IEEE, 762-765 (2005) describes a surface structure produced by a network of holes positioned in a metal material such as tungsten (W), the explored dimensions for the radius, the thickness of the film and the period of the patterns being of the order of one micrometer.

The object of the invention is to propose surface structuration with an innovative geometry for obtaining wavelength selectivity, adapted to solar heat absorbers, and compatible with a low cost industrial manufacturing method, which may be applied on a large scale on a large surface and compatible with refractory materials at high temperatures.

For this purpose, the object of the invention is a textured surface structure for a solar heat absorber capable of operating at high temperatures comprising

a substrate having a planar or curved surface, made in a first optically reflective, thermally stable material and having a set of surface elements defining a reference extension surface, and

a set of textural elements having a same elementary structure and distributed along the reference surface according to a two-dimensional layout,

characterized in that the elementary structure of a textural elements includes a cavity, formed in the substrate, with an edge of a same level as the reference surface and a bottom, and flaring from the bottom as far as the edge, and

crown outgrown with respect to the reference surface and immediately positioned at the periphery of the edge of the cavity.

According to embodiments, the surface structure includes one or several of the following features, taken alone or as a combination:

two crowns immediately close to each other are separated everywhere by a gap or touch each other in a single point, and have a separation distance s, greater than or equal to zero, less than or equal to 500 nm, and preferably less than or equal to 100 nm;

the elementary structure has a cylindrical symmetry around an axis of symmetry crossing the bottom of the cavity and normal to the reference surface; and

the cavity has a diameter D, considered at the reference surface, and a height H, defined as the distance separating the bottom from the reference surface, such that a first H/D form ratio, defined as the ratio of the height H over the diameter D of the cavity is strictly greater than one; and,

the crown has a base width l, defined as the greatest width of a radial section of the crown while being equal to the difference between an external radius corresponding to the external contour of the crown and an internal radius corresponding to the internal contour of the crown taken at the level of the reference surface, and has a height h, defined as the distance separating the reference surface and the greatest of a single or several crests of the crown, the base width I and the height h being such that a second form factor h/l, defined as the ratio of the height over the base width of the crown is strictly greater than one; and

the transverse diameter D, the height H of the cavity, the base width I, the height h of the crown are all less than or equal to 10 μm, preferably equal to 1 μm;

the profile of a radial section of the cavity is a first planar curve symmetrical by the axis of symmetry, the axis of symmetry being oriented positively from the bottom towards the reference surface and having as an origin its point of intersection with the reference surface, and

the point of intersection of the axis of symmetry with the bottom is a minimum of the first planar curve, and

the distance separating two symmetrical points of the first planar curve located at a same decreasing level when the level corresponding to the symmetrical points decreases;

the first planar curve is a portion of a parabola or a portion of the envelope of a two-dimensional cone;

the profile of a radial half-section of the crown along a radial half-plane is a second planar curve defined by an evolution function of the level of the crown according to the radius thereof,

the evolution function of the profile of the level of the crown being with positive values and defined on a closed interval of radii comprised between the internal radius of the crown and the external radius of the crown, and

the value of the level of the crown corresponding to the internal radius being equal to zero and the value of the level of the crown corresponding to the external radius being greater than or equal to zero and less than half of the height h; and

the evolution function first being increasing over a first sub-interval until it attains a level threshold hₜₕᵣₑₛₕ strictly greater than half of the height h, and then

on a second sub-interval changing over time above the level threshold hₜₕᵣₑₛₕ until the height of the crown is attained and then changing over time until the threshold level hₜₕᵣₑₛₕ is again attained, and then

on a third sub-interval decreasing until the level corresponding to the external radius is attained;

the crowns are in one piece with the substrate and consist of the same first material;

the textured surface structure comprises a layer of a second material, deposited on the whole of the cavities and of the crown), and of areas of the reference surface of the substrate not covered by the crowns,

the second material consisting of one or several layers;

the crowns consist of a second material different from the first material making up the substrate;

the second material is a material comprised in the set consisting of metals such as tungsten, molybdenum, metal alloys like steel, anti-reflective materials such as silicon oxide;

the first material is a material comprised in the set consisting of refractory metals such as tungsten, molybdenum . . . , ceramics such as silicon carbide and alloys such as steel;

the layout of the textural elements having the same elementary structure along the reference plane is achieved as a paving of elementary networks of textural elements,

the elementary networks having a same unit cell configuration comprised in the set formed by hexagonal meshes, square meshes, triangular meshes and being characterized by a compactness level of the textural elements;

The object of the invention is also a method for manufacturing a textured surface structure for a solar heat absorber capable of operating at high temperatures comprising a first step consisting of providing a substrate having a planar or curved surface, made in an optically reflective, thermally stable first material, and having a reference surface, characterizing that it further comprises a second step, performed subsequently to the first step, consisting of

making a set of textural elements having a same elementary structure and distributed along the reference surface according to a two-dimensional layout, the elementary structure of a textural element including

a cavity, formed in the substrate, with an edge at the same level as the reference surface and a bottom, and flaring from the bottom as far as the edge, and

crown outgrown with respect to the reference surface and immediately positioned at the periphery of the edge of the cavity.

According to particular embodiments, the manufacturing method includes one or several of the following features, taken alone or as a combination:

the second step comprises the successive steps consisting of:

in a third step depositing on the smooth surface of the substrate forming the reference surface, a film of lenticular particles in a compact assembly, the lenticular particles being configured for micro-focusing a laser radiation beam on the substrate, and then,

in a fourth step subjecting the lenticular particles to a pulsed laser flux configured so that when the micro-focused energy attains an ablation threshold of the first material making up the substrate, a cavity is formed in the substrate at the location of a contact area of the lenticular particle while being accompanied by a rise of material forming a crown around the cavity;.

the manufacturing method defined above comprises a step for depositing a second mono- or multi-layer material on the reference surface of the substrate, performed between the first and second steps, the second material having low emissivity to infrared radiation, and

the second step comprises the successive steps consisting of:

in a fifth step, depositing on the planar surface of the second material a film of lenticular particles in a compact assembly, the lenticular particles being configured for micro-focusing a laser radiation beam on the layer of the second material and the substrate immediately below, and then,

in a sixth step subjecting the lenticular particles to a pulsed laser flux configured so that when the micro-focused energy attains an ablation threshold of the second and first materials, a cavity is formed in the second material and in the substrate at the location of a contact area of the lenticular particle while being accompanied by a rise of the second material forming a crown around the cavity pierced in the substrate;

the deposition of a compact film of lenticular particles is produced by a deposition technique comprised in the set consisting of a Langmuir-Blodgett, Langmuir-Schaefer technique and spin coating;

the lenticular particles are particles in a dielectric material comprised in the set formed by oxides, silica, quartz, polymers such as polystyrene or particles in an electrically conducting material comprised in the set consisting of gold, silver, stainless steel.

The lenticular particles have the shape of a sphere or of a sphere modified by a chemical etching, thermal etching, plasma etching process applied in an etching step performed between the third and fourth steps, or between the fifth and sixth steps, the diameter of the sphere being comprised between a few tens of nm and several tens of microns.

the laser beam applied on the film of the particles is collimated and delivered by pulses ranging from one femto-second to one nanosecond, preferably ranging from one femto-second to one picosecond;

the manufacturing method comprises a step for cleaning the residual lenticular particles performed after the second step;

the manufacturing method comprises a step for depositing a second mono- or multi-layer material, performed after the second step or the cleaning step.

The invention will be better understood upon reading the description of several embodiments which will follow, only given as examples and made with reference to the drawings wherein:

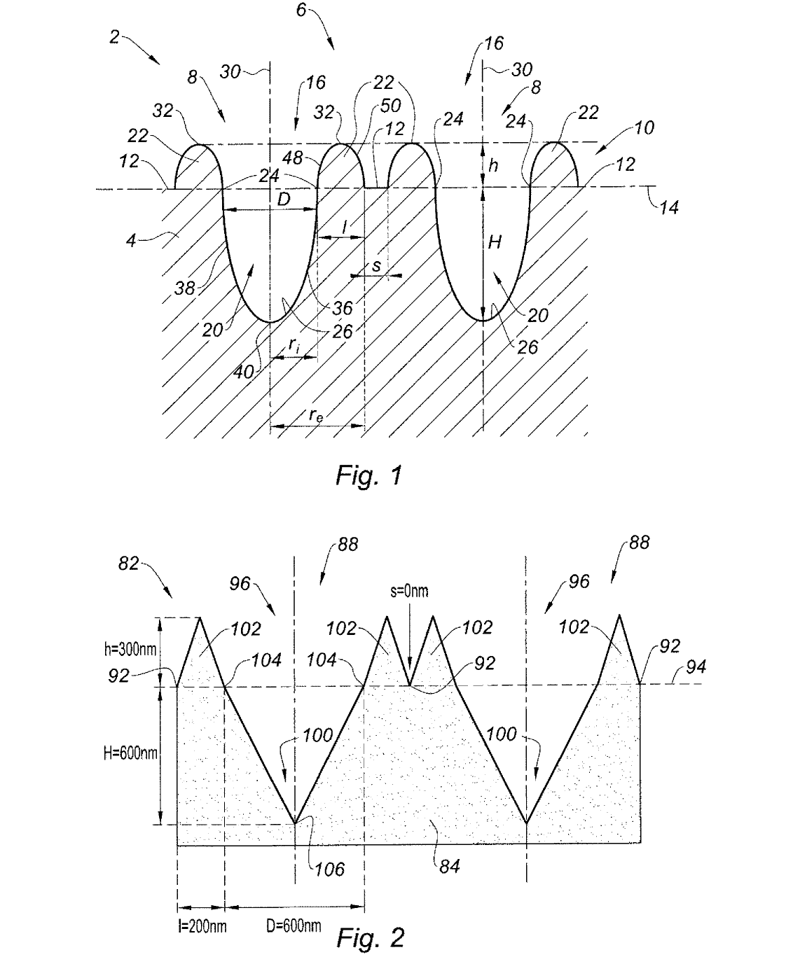

FIG. 1 is a view of a first embodiment of a surface structure of the invention;

FIG. 2 is a view of a first embodiment of a surface structure of the invention;

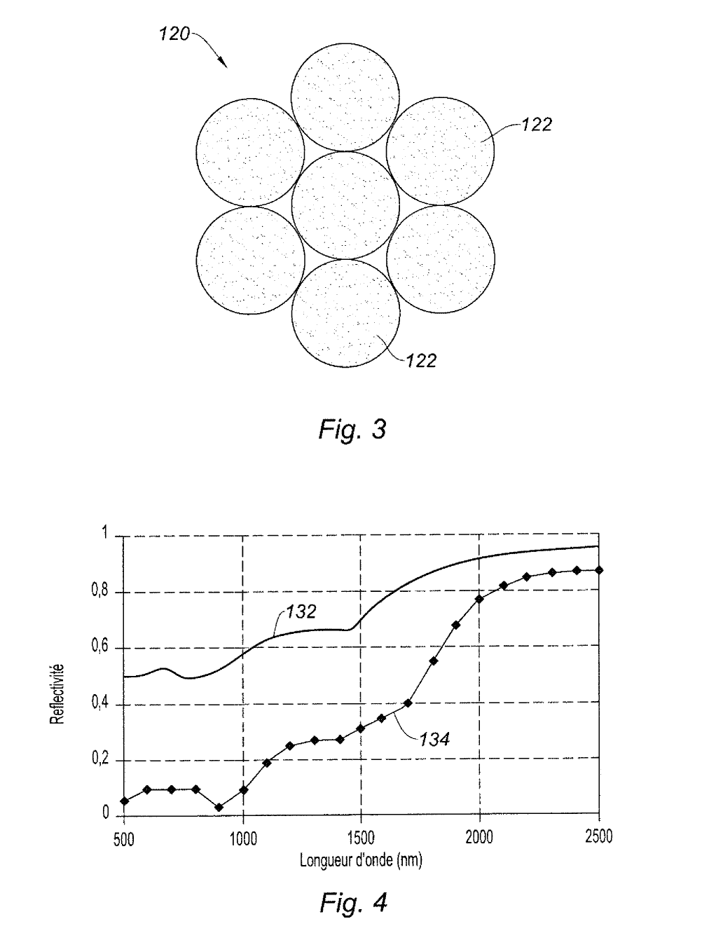

FIG. 3 is a view of an example of an elementary network of textural elements of FIG. 2 organizing the two-dimensional layout of a surface structure according to the invention;

FIG. 4 is a comparative view of the performances in terms of reflectivity between the surface structure of FIGS. 2 and 3 and a standard structure of a smooth tungsten plane;

FIG. 5 is a comparative view of the performances in terms of reflectivity between the surface structure of FIGS. 2 and 3 and a standard textured surface structure including circular holes and without any flange;

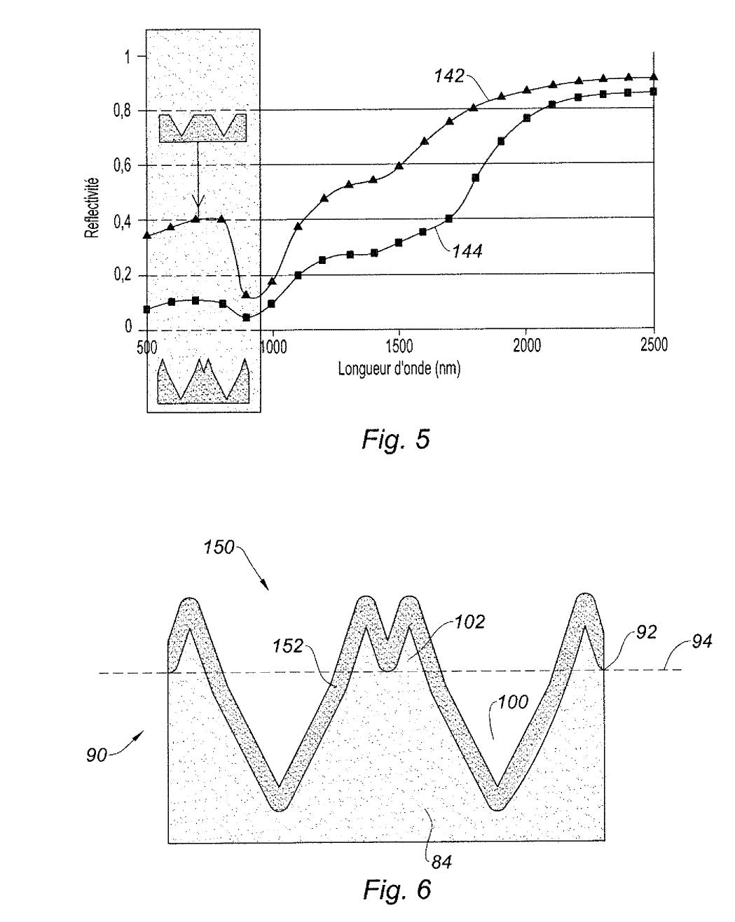

FIG. 6 is a view of a third embodiment of a surface structure of the invention;

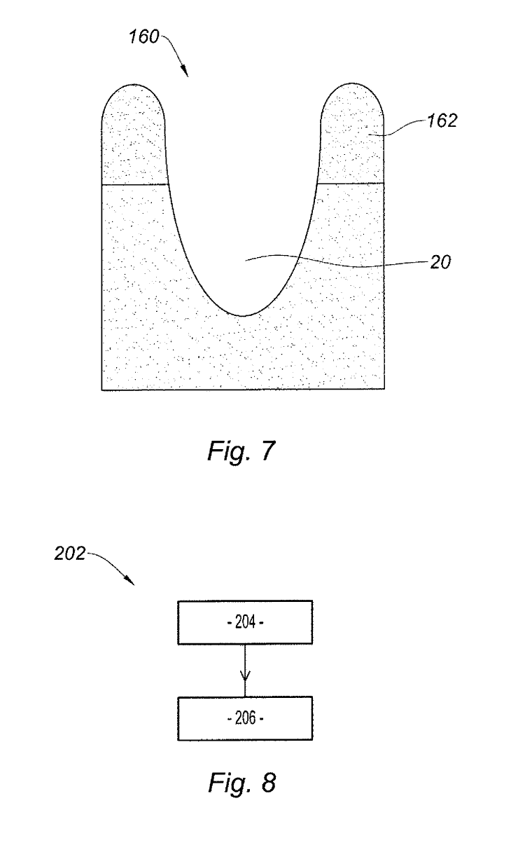

FIG. 7 is a view of a fourth embodiment of a surface structure of the invention;

FIG. 8 is a flow chart of a general method for manufacturing a surface structure of FIGS. 1-3 and 6-7;

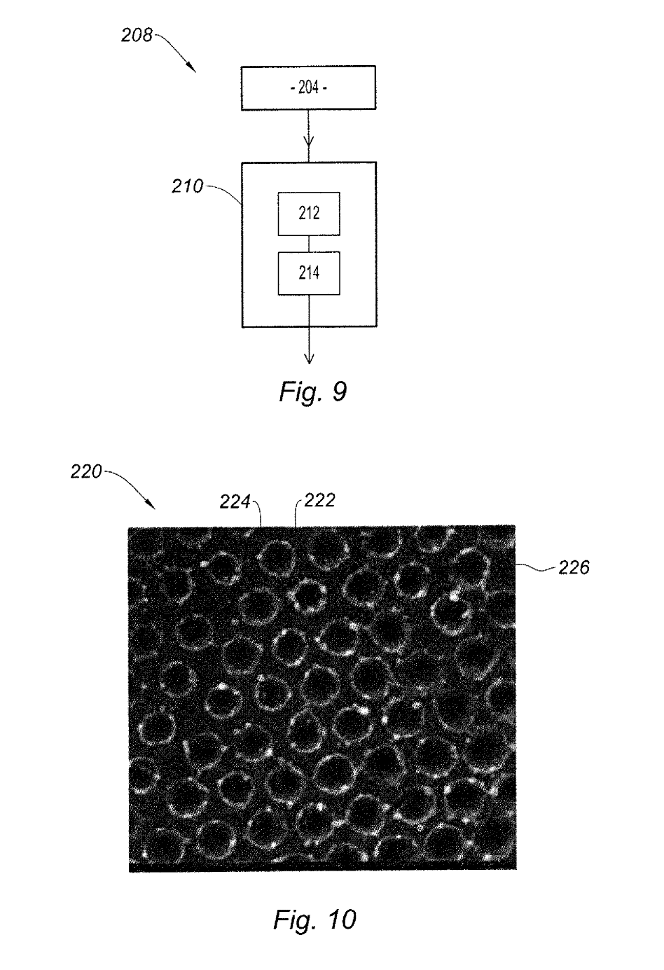

FIG. 9 is a flow chart of a first embodiment of the general manufacturing method of FIG. 7;

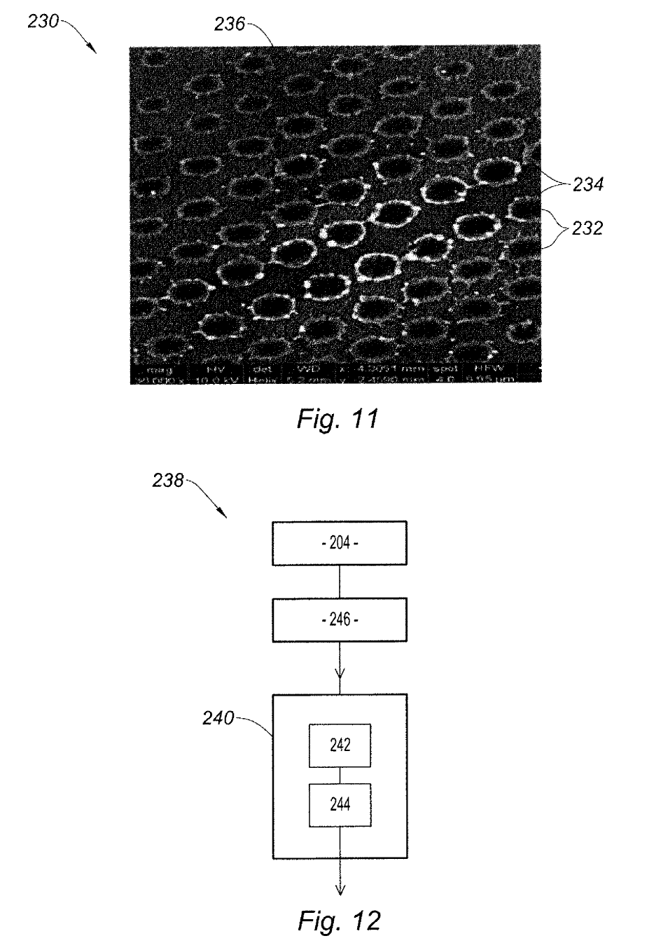

FIGS. 10 and 11 are views under a scanning electron microscope of surface structures of FIG. 1 respectively produced with a femtosecond laser and a picosecond laser;

FIG. 12 is a flow chart of a second embodiment of the general manufacturing method of FIG. 7;

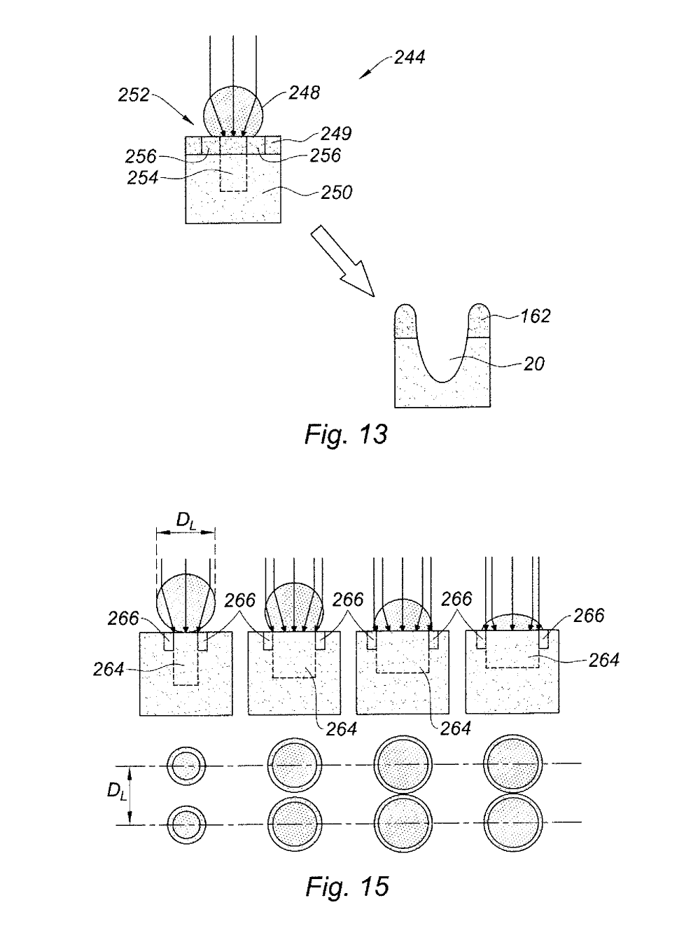

FIG. 13 is a view of the ablation-vaporization and melting areas of the first and second materials when the second embodiment of the method of FIG. 12 is applied;

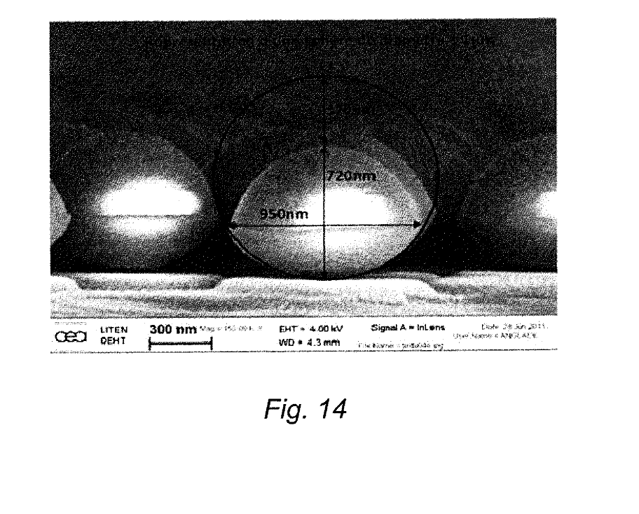

FIG. 14 is a view of lenticular particles having a modified spherical shape;

FIG. 15 is a comparative view of the ablation-vaporization and melting areas of the first and second materials according to the modified shape of the lenticular particles when the second embodiment of the method of FIG. 12 is applied.

According to FIG. 1 and to a first embodiment, a textured surface structure 2 for a solar heat absorber, capable of operating at high temperatures, comprises a substrate 4 having a surface, here a planar surface, and a set 6 of textural elements 8.

The substrate 4 consists in a first optically reflective material, here a refractory material, thermally stable. The substrate 4 has a set of 10 of surface elements, here planar elements, 12 belonging to a same reference surface 14, here a reference plane illustrated at the end in FIG. 1. Alternatively, other smooth reference surfaces may be used such as for example a cylindrical surface, a paraboloid surface, a hyperboloid surface . . . .

The textural elements 8 had a same elementary structure 16 and are distributed along the reference plane 14 according to a two-dimensional periodic layout.

In FIG. 1, this two-dimensional layout is not visible because of the illustration of a particular section of the surface structure 2, here limited to two textural elements 8 immediately close to each other for the sake of simplification.

The elementary structure 16 of a textural element 8 includes a cavity 20 and a crown 22 or flange.

The cavity 20, formed in the substrate 4, includes an edge 24 and a bottom 26, the edge being defined as the contour of the cavity 20 at the reference plane 14.

The cavity 20 is flared from the bottom 26 as far as the edge 24.

The crown 22 outgrown with respect to the reference plane 14 is immediately positioned at the periphery of the edge of the cavity 20.

Both crowns 22 of any pair of immediately near textural elements are separated by a gap.

As illustrated in FIG. 1, two immediately near crowns have a separation distance s, of less than or equal to 500 nm, preferably less than or equal to 100 nm, or even zero, the distance s being defined as the minimum of the distances separating any two points of both crowns, one of the points being taken on a crown, the other point being taken on the other crown, and the distance s being reached on a single pair of points.

Here, the crowns are of one piece with the substrate and consisting of the same first material.

Here, in FIG. 1, the elementary structure 16 has cylindrical symmetry around an axis of symmetry 30 which crosses the bottom 26 of the cavity 20 and which is normal to the reference plane 10.

The cavity 20 has a diameter D, considered at the reference plane 14, and a height H, defined as the distance separating the bottom 26 from the reference plane 14, such that a first H/D shape ratio, defined as the ratio of the height H over the diameter D of the cavity is strictly greater than one.

The crown 22 has a base width I which is defined as the largest width of the base of a radial section of the crown 22 and which is equal to the radial distance separating the edge 24 of the cavity 20 and the external contour of the crown 22.

The crown 22 has a height h, defined as the distance separating the reference plane 14 and the greatest of a single or several of the crests of the crown. The base width I and the height h are such that a second form factor h/l, defined as the ratio of the height over the base width of the crown is strictly greater than one.

Here, in FIG. 1 and in a particular way, the crown 22 has a single crest 32. Alternatively, the crown has at least two crests.

The transverse diameter D, the height H of the cavity 20, the base width l , the height h of the crown 22 are all less than or equal to 10 μm, preferably equal to 1 μm.

When, as illustrated in FIG. 1, the elementary structure 16 has cylindrical symmetry around an axis of symmetry 30, a profile 36 of a radial section of the cavity 20 is a first planar curve 38.

The first planar curve 38 is symmetrical with respect to the axis of symmetry 30, positively oriented from the bottom 26 of the cavity 20 towards the reference plane 14, graduated in levels and having as an origin its intersection with the reference plane 14.

The axis of symmetry 30 has a point 40 of intersection with the bottom of the cavity 20 which is a minimum of the first curve 38, and the distance separating two symmetrical points of the first curve, located at a same level, decreases when the level corresponding to the symmetrical points decreases.

The first planar curve 38, illustrated in FIG. 1, is for example a portion of a parabola.

When, as illustrated in FIG. 1, the elementary structure 12 has cylindrical symmetry around an axis of symmetry 30, a profile 48 of a radial section of the crown 22 along a radial half-plane is a second planar curve 50 defined by a function of the time-dependent change in the level of the crown 22 versus the radius r of the latter.

The evolution function of the profile of the level of the crown is with positive values and it is defined on a closed interval of radii comprised between the internal radius ri of the crown 22, equal to the radius of the cavity D/2, and the external radius re of the crown 22, equal to the internal radius ri of the crown increased by its width I. The value of the level of the crown 22 to the internal radius is equal to zero and the value of the level of the crown 22 at the external radius is greater than or equal to zero and less than half the height h of the crown.

Generally, the evolution function of the profile of the crown first increases over a first sub-interval until a level threshold hₜₕᵣₑₛₕ is attained, greater than or equal to half of the height h of the crown. And then, on a second sub-interval, it changes above the level threshold ₜₕᵣₑₛₕ until the height h of the crown is attained and then changes until it attains again the threshold. Next, on a third sub-interval, the evolution function decreases until the level corresponding to the external radius is attained.

In the particular case of the crown illustrated in FIG. 1, the second curve 50 is a portion of a parabola and the level threshold coincides with the level of the single crest, i.e. the height h of the crown 22.

According to FIG. 2, a second embodiment of a surface structure 82 is similar to the surface structure 2 according to the first embodiment and differs therefrom by the profile curves of the cavities and of the crowns. Here, the first planar curve is a portion of the envelope of a two-dimensional cone, and the second planar curve is a portion of the envelope of a two-dimensional oriented in the opposite direction. Thus, the surface structure 82 comprises textural elements 88, each formed with a hole or a conical cavity 100 and with a crown 102. The crown 102 outgrown with respect to a reference plane 94 of the substrate 84, has an outer shape which is also conical. The reference plane 94 is defined here also like the surface structure 2 of FIG. 1 as an extension plane of a set of planar surface elements forming the joints of the crowns between each other. In FIG. 2 this planar two-dimensional extension is not visible because of the fact that both illustrated crowns touch each other locally in one point and that the sectional plane passes through this point and the axes of cylindrical symmetry. Nevertheless, this two-dimensional extension actually exists. The dimensions D, I, s, H, h of the surface structure 82 are equal to 600 nm, 200 nm, 0 nm, 600 nm and 300 nm respectively.

Alternatively, the elementary structure does not have an axis of cylindrical symmetry.

Generally, the layout of the textural elements having the same elementary structure along the reference plane is achieved as a paving of elementary networks of textural elements. The elementary networks have a same mesh configuration comprised in the set formed by the hexagonal meshes, the square meshes, the triangular meshes and are characterized by a compactness degree of the textural elements between them.

As an example, according to FIG. 3, the particular configuration of an elementary network 120 with compact hexagonal meshes is illustrated. Each of the six discs 122 of the elementary network 120 represents a textural element. This elementary network 120 organizes the layout according to the reference plan of the second embodiment of the surface structure illustrated in FIG. 2. Thus, a disc 122 in particular corresponds to a textural element 88 of FIG. 2.

According to FIG. 4, the performances are compared in terms of optical reflectivity of a first planar surface structure in tungsten (W) and those of a second textured surface structure in tungsten along the geometry of the second embodiment described in FIGS. 2 and 3. A first layer 132 represents the evolution in the reflectivity versus the wavelength for the first structure while a second curve 134 represents the evolution in the reflectivity versus the wavelength for the second structure. The beneficial provision of texturation by the geometry of the invention appears clearly since, with a threshold wavelength close to 2 μm, the optical selectivity shown by the second curve 134 is brought clearly closer to the ideal selectivity curve of a solar heat absorber than the optical selectivity shown by the first curve 132.

According to FIG. 5, the performances are compared in terms of optical reflectivity between a first standard surface structure in tungsten (W) with conical holes without any flanges distributed in a compact hexagonal configuration with cavities on the one hand, and a second textured surface structure in tungsten according to the geometry of the second embodiment of the invention, i.e. the same structure as the first structure but with a flange at the periphery of each hole and outgrown relatively to the plane of the substrate. A first curve 142 represents the evolution in the reflectivity versus the wavelength for the first structure while a second curve 144 represents the evolution in the reflectivity versus the wavelength for the second structure. The beneficial provision of the flange on the selectivity of the optical response is clearly apparent since the optical selectivity exhibited by the second curve 144 is clearly brought closer to the ideal selectivity curve of a solar heat absorber than the optical selectivity shown by the first curve 142.

According to FIG. 6 and a third embodiment of the invention, derived from the second embodiment described in FIG. 2, a textured surface structure 150 comprises the surface structure 90 of FIG. 2 and above a layer 152 in a second material. The layer 152 is deposited on the whole of the cavities 100 and of the crowns 102 forming the textural elements, and of the non-recessed areas 92 of the reference plane 94 of the substrate 84, non-covered by the crowns 102. The second material consists of one or several layers.

According to FIG. 7 and a fourth embodiment of the invention, a textured surface structure 160 is derived from the surface structure 2 of FIG. 1 by replacing the crowns 22 of one piece with the substrate and in a same first material as the latter with crowns 162 consisting in a second material different from the first material making up the substrate.

Advantageously, a structure with two or multiple materials as proposed in the fourth embodiment gives the possibility for example of obtaining a crown and a medium surrounding the cavity consisting of different materials. This gives the possibility of further optimizing the base structure of the texturing element by selecting for example different optical properties for the second upper material of the crown and for the first inner material of the substrate. Preferably, the first upper material is an infrared reflector metal which gives the possibility of limiting emissivity in the infrared of the structure and thus improve the performance of the absorber. The first inner material of the substrate is an absorbant material in the range of visible light.

The first material is a material comprised in the set of refractory metals such as tungsten (W), molybdenum (Mo), platinum (Pt), nickel (Ni), silicon (Si), . . . , ceramics such as silicon carbide and alloys such as steel.

The second material making up either the thin layer deposited on a substrate textured beforehand and including in one piece the crowns in the same first material, or a material of the crown of the first material may be any type of material and in particular:

a metal, such as for example molybdenum, tungsten, nickel, platinum.

an alloy like steel,

a material or a set of materials allowing improvement in the optical function, as an antireflective agent such as for example silicon oxide,

a material or a set of materials giving the possibility of improving the function of resisting to ageing or of protection towards the environment, with silicon oxide.

According to FIG. 8, a method 202 for manufacturing a textured surface structure for a solar heat absorber, capable of operating at high temperatures and as described in FIGS. 1 to 3 and 6 to 7 is based on the laser/particles/substrate interaction.

The method 202 globally comprises a first step 204 followed by a second step 206.

In the first step 204, a substrate having a planar or regularly curved surface like for example that of a cylinder, a sphere, a paraboloid or a hyperboloid is provided. The substrate consists in a first optically reflective material, thermally stable for high temperatures which exceed 1,000° C., and has a reference surface. The first material is for example a refractory material and/or a metal.

Next, in the second step 206, a set of textural elements is made. The structural elements have a same elementary structure and are distributed along the reference surface according to a two-dimensional layout. The elementary structure of a textural element includes a cavity, formed in the substrate, and a crown or flange. The cavity includes an edge of a same level as the smooth reference surface and a bottom; it is flared from the bottom as far as the edge. The crown, outgrown with respect to the smooth reference surface, is immediately positioned at the periphery of the edge of the cavity.

According to FIG. 9 and to a first particular embodiment 208 of the general method 202 described in FIG. 8, the second step 206 is a step 210 which comprises a third step 212 and a fourth step 214, performed in succession.

In the third step 208, a film of lenticular particles in a compact assembly is deposited on the surface of the substrate forming the surface in the reference plane, the lenticular particles being configured for micro-focusing a laser radiation beam on the substrate.

Next, in the fourth step 210 the lenticular particles are subject to a pulsed laser flux, configured so that when the energy of the laser, individually micro-focused by each lenticular particle, attains an ablation threshold of the first material making up the substrate, a cavity is then formed in the substrate at the location of a contact area of the lenticular particle while being accompanied by a rise of material which forms a crown around the cavity.

Thus, by the method 202 with only a few technological steps, mainly the deposition of lenticular particles (third step 208) and laser shots (fourth step 210), it is possible to obtain at the surface of a refractory material a structuration of the compact hexagonal type with microstructures formed with holes surrounded by crowns as described in FIGS. 1 to 2 and 6 to 7.

The first material making up the substrate may be, as this has already been seen, any types of solid materials, like for example refractory metals such as tungsten or molybdenum, ceramics like silicon carbide, or alloys like steels.

The surface of the substrate should have a roughness Ra of less than 0.1 μm. The substrate provided in the first step therefore underwent a step for preparing its surface, for example by polishing, beforehand.

The lenticular particles are particles in a dielectric material like for example oxides, silica, quartz, polymers such as polystyrene which act as optical focusing elements.

Alternatively, the lenticular particles are particles in an electrically conducting material like for example gold and silver which then apply a concentration process of the different field by a plasmon effect.

The lenticular particles have the shape of a sphere, or a sphere modified by a process of chemical, thermal, plasma etching applied in an etching step performed between the third and fourth steps, the diameter of the sphere being comprised between a few tens of nm to several tens of microns, preferably from 250 nm to 2 μm.

The techniques for depositing a compact film of particles allowing the application of the third step are numerous and known, for example the Langmuir-Blodgett, Langmuir-Schaefer method and spin coating.

The Langmuir-Blodgett method is for example described in the article of S. Acharya et al., entitled <<Soft Langmuir-Blodgett Technique for Hard Nanomaterials >>, Advanced Materials, 2009, 21, 2959-298, and the article of M. Bardosova entitled<<The Langmuir-Blodgett Approach to Making Colloidal Photonic crystals from Silica Spheres >>, Advanced Materials, 2010, 22, 3104-3124.

The spin-coating method is for example described in the article of T. E. Bauert, entitled <<Self-Assembling of Particles Monolayers by Spin-Coating>>, European Cells and Materials, Vol. 10, Suppl. 5, 2005.

The Langmuir-Blodgett method uses a carrier liquid, for example water, in which the so-called <<target>>substrate is immersed beforehand in a vertical position on which the monolayer of lenticular particles of spherical shape has to be transferred. The lenticular particles are dispensed at the surface of the liquid on which they disperse. A mechanical barrier is then set into motion for gradually reducing the surface occupied by the particles in order to compress them. When the compact film is formed, the substrate is set into motion for depositing by capillarity the film at its surface. The barrier should accompany this drawing movement in order to retain the compression of the particles.

The approach, applied in the fourth step, is known and described in the article of Z. Chen et al., entitled <<Photonic nanojet enhancement of backscattering of light by nanoparticles: a potential novel visible-light ultramicroscopy technique>>, Apr. 2004, Vol. 12, No. 7, Optics Express 1214. It consists of making use of the micro- or nano-spheres (polystyrene, silica, quartz . . . ) like <<lenses>>for focusing. Thus, in this configuration, a collimated or focussed beam illuminates the compact film of particles. The energy of the beam is then concentrated on the substrate by each of the spheres. This method thus gives the possibility from a single illumination beam and the dimension of which considerably exceeds that of the spheres of obtaining on the substrate a<<multipoint>>focusing much lower than the diffraction limit of the incident beam and with a submicron periodicity.

The light sources used in this approach may be pulsed, collimated or focused laser beams for etching or directly ablating the substrate. More specifically, the pulsed lasers used are for example femtosecond lasers which give the possibility of etching many materials because of the laser-material interaction mode specific to ultrashort pulses. The ultrashort laser pulses cover a range of pulse durations ranging from one femtosecond (10⁻¹⁵ s) to one picosecond (10⁻¹² s). It is also possible to use nanosecond lasers considered as <<long>>pulses.

According to FIG. 10, a first surface structure 220 with peripheral holes 222 and crowns 224 in one piece with the substrate 226 and in a same first material was obtained by a method of the first embodiment in which a laser radiation is applied on a layer of silicon dioxide particles with a diameter of 1 μm directly deposited on the steel substrate.

The laser used is a femtosecond Ti:Sa laser from Bright Raymax Lasers™, with a wavelength of 800 nm, with a maximum power of 2.5 W, with a frequency of 5 kHz and a Gaussian beam.

According to FIG. 11, a second surface structure 230 with peripheral holes 232 and crowns 234 of one piece and in a same first material was also obtained by a method of the first embodiment wherein a laser radiation is applied on a layer of particles of silicon dioxide with a diameter of 1 μm directly deposited on the steel substrate 236.

The laser used here is a picosecond laser with a wavelength of 1,064 nm, with a maximum power of a few Watts, with a frequency of 1 kHz and with a Gaussian beam.

It should be noted that generally, after the fourth step of the laser shots, a step for cleaning the residual particles is applied according to one of the numerous techniques known to this day. For example, a conventional method used for removing the residual particles consists of immersing the substrate in a solvent such as water, ethanol or acetone in the presence of ultrasound for a few minutes.

Alternatively and optionally, a passivation layer of the surface structure may be deposited, such as for example silicon dioxide, silicon nitride with a method of the PVD, CVD, sol-gel, or printing type.

According to FIGS. 12 and 13, a second 238 particular embodiment of the general method 202 of FIG. 8 is described, wherein the second step 206 is a step 240 which comprises a fifth step 242 and a sixth step 244, performed in succession and respectively replacing the third step 208 and the fourth step 210.

The method 238 according to the second embodiment comprises a step 246 for depositing a second mono- or multi-layer material on the reference plane of the substrate, performed between the first and second steps 204, 240, the second material having low emissivity to infrared radiation.

In the fifth step 242, a film of lenticular particles is deposited in a compact assembly on the planar surface of the second material. The lenticular particles are configured so as to micro-focus a laser radiation beam onto the layer of the second material and the substrate immediately located below. In FIG. 13, only a single lenticular particle 248 is illustrated.

In the sixth step 244, the lenticular particles are subject to a pulsed laser flux, configured so that when the micro-focused energy attains an ablation threshold of the second and first materials, 249, 250, a cavity is formed in the second material and in the substrate at the location of a contact area 252 of the lenticular particle while being accompanied by a rise of the second material forming a crown around the cavity pierced in the substrate. According to FIG. 13, the contact area 252 is split up into a first central area 254 for spraying and vaporizing the first and second materials which are contained therein, and into a second peripheral area 256 for melting the sole second material.

Thus, a structured structure with two or multiple materials is directly obtained by the method for exposing to the laser the carpet of nanoparticles as shown in FIG. 13.

Thus, with this method, a crown and a medium surrounding the cavity consist of different materials. This allows further optimization of the base structure by for example selecting different optical properties for the second upper material and for the first lower material of the substrate. Preferably, the upper material will be an infrared reflector metal which will give the possibility of limiting the emissivity in the infrared of the structure and thereby improve the performance of the absorber. The lower material forming the substrate will be an absorbant material in the range of visible light.

In the aforementioned configurations, the dimensions of the structure elements may be adapted by adjusting diverse parameters like the nature of the particles for micro-focusing the energy of the laser beam.

In order to adjust the dimension of the hole and of the crown, microspheres or microlenses, the shape of which has been modified, for example by plasma etching, may be used. FIG. 14 illustrates an example of the modification of the geometry of spherical silica particles by action of a plasma CHF₃/O_{2.}

According to FIG. 15, the adaptation of the geometries of the flanges and cavities by modifying the shape of the microlenses is demonstrated. The modification of the focusing gives the possibility of adapting the sizes of the ablation 264 and melting 266 areas and therefore adapting the size of the cavities and flanges, as well as the spacing between flanges.

The parameters of the laser such as the wavelength, the repetition rate, the pulsed width, the polarization, the space and time shape of the beam, the fluence also give the possibility of modulating the geometry of the surface structure.

It should be noted that in alternatives, the steps for cleaning, spreading the particles, for exposure to the laser beam may be carried out several times for increasing the height of the holes.

Alternatively, it is also possible to fix the particles to the substrate surface with chemical bonds, this giving the possibility of shooting with more power and of digging deeper.

1. A textured surface structure for a solar heat absorber able to operate at high temperatures comprising:
a substrate having a planar or curved surface, consisting in an optically reflective, thermally stable first material and having a set of surface elements defining a reference surface, and
a set of textural elements having a same elementary structure and distributed along the reference surface according to a two-dimensional layout,
wherein the elementary structure of a textural element includes
a cavity, formed in the substrate, with an edge of a same level as the reference surface and a bottom, and flaring from the bottom as far as the edge, and
a crown outgrown with respect to the reference surface and immediately positioned at the periphery of the edge of the cavity.

2. The surface structure according to claim 1, wherein two crowns immediately close to each other, are separated everywhere by a gap or touch each other in a single point, and have a separation distances greater than or equal to zero, less than or equal to 500 nm, and preferably less than or equal to 100 nm.

3. The surface structure according to claim 1, wherein
the elementary structure has a cylindrical symmetry around an axis of symmetry crossing the bottom of the cavity and normal to the reference surface; and
the cavity has a diameter D, considered at the reference surface, and a height H, defined as the distance separating the bottom from the reference surface, so that a first form ratio H/D, defined as the ratio of the height H over the diameter D of the cavity is strictly greater than one; and
the crown has a base width defined as the greatest width of a radial section of the crown while being equal to the difference between an external radius corresponding to the external contour of the crown and an internal radius corresponding to the internal contour of the crown taken at the level of the reference surface, and has a height h, defined as the distance separating the reference surface and the greatest of a single or several of the crests of the crown, the base width l and the height h being such that a second form factor h/l, defined as the ratio of the height over the base width of the crown is strictly greater than one; and
the transverse diameter D, the height H of the cavity, the base width l, the height h of the crown are all less than or equal to 10 μm, preferably equal to 1 μm.

4. The surface structure according to claim 3, wherein
the profile of a radial section of the cavity is a first planar curve symmetrical by the axis of symmetry, the axis of symmetry being positively oriented from the bottom towards the reference surface and having as an origin its point of intersection with the reference surface, and
the point of intersection of the axis of symmetry with the bottom is a minimum of the first planar curve, and
the distance separating two symmetrical points of the first planar curve located at a same decreasing level when the level corresponding to the symmetric points decreases.

5. The textured surface structure according to claim 4, wherein the first planar curve is a portion of a parabola or a portion of the envelope of a two-dimensional cone.

6. The textured surface structure according to claim 3, wherein
the profile of a radial half-section of the crown along a radial half-plane is a second planar curve defined by an evolution function of the level of the crown according to the radius of the latter,
the evolution function of the profile of the level of the crown being with positive values and defined on a closed interval of radii comprised between the internal radius of the crown and the external radius of the crown, and
the value of the level of the crown corresponding to the internal radius being equal to zero and the value of the level of the crown corresponding to the external radius being greater than or equal to zero and less than half of the height h; and
the evolution function first being increasing on a first sub-interval until it attains a level threshold hₜₕᵣₑₛₕ strictly greater than half the height h, and then
on a second sub-interval changing over time above the level threshold hₜₕᵣₑₛₕ until the height of the crown is attained and then changing over time until the threshold level hₜₕᵣₑₛₕ is again attained, and then
on a third sub-interval decreasing until the level corresponding to the external radius is attained.

7. The textured surface structure according to claim 1, wherein the crowns are in one piece with the substrate and comprise the same material.

8. The textured surface structure according to claim 7, comprising a layer of a second material, deposited on the whole of the cavities and of the crowns, and of areas of the reference surface of the substrate not covered by the crowns, the second material consisting of one or several layers.

9. The textured surface structure according to claim 1, wherein the crowns comprise a second material different from the first material making up the substrate.

10. The textured surface structure according to claim 8, wherein the second material is a material comprised in the set consisting of metals such as tungsten, molybdenum, metal alloys like steel, anti-reflective materials such as silicon oxide.

11. The textured surface structure according to claim 1, wherein the first material is a material comprised in the set consisting of the refractory metals such as tungsten, molybdenum, ceramics such as silicon carbide and alloys such as steel.

12. The textured surface structure according to claim 1, wherein the layout of the textured elements having the same elementary structure along the reference plane is achieved as a paving of elementary networks of textural elements, the elementary networks having a same mesh configuration comprised in the set formed by hexagonal meshes, square meshes, triangular meshes and being characterized by a compactness degree of the textural elements.

13. A method for manufacturing a textured surface structure for a solar heat absorber capable of operating at high temperatures comprising a first step consisting of providing a substrate with a planar or curved surface, made in an optically reflective, thermally stable material and having a reference surface, further comprising a second step, performed subsequently to the first step, consisting of:
making a set of textural elements having a same elementary structure and distributed along the reference surface according to a two-dimensional layout, the elementary structure of a textural element including
a cavity, formed in the substrate, having an edge of the same level as the reference surface and a bottom, and flaring from the bottom as far as the edge, and
a crown outgrown with respect to the reference surface and immediately positioned at the periphery of the edge of the cavity.

14. The manufacturing method according to claim 13, wherein the second step comprises the successive steps comprising:
in a third step depositing on the smooth surface of the substrate forming the reference surface, a film of lenticular particles in a compact assembly, the lenticular particles being configured for micro-focusing a laser radiation beam on the substrate, and then,
in a fourth step subjecting the lenticular particles to a pulsed laser flux configured so that when the micro-focused energy attains an ablation threshold of the first material making up the substrate, a cavity is formed in the substrate at the location of a contact area of the lenticular particle while being accompanied by a rise of material forming a crown around the cavity.

15. The manufacturing method according to claim 13, comprising a step for depositing a second mono- or multi-layer material on the reference surface of the substrate, performed between the first and second steps, the second material having low emissivity to infrared radiation, and wherein the second step comprises the successive steps consisting of:
in a fifth step depositing on the planar surface of the second material a film of lenticular particles in a compact assembly, the lenticular particles being configured for micro-focusing a laser radiation beam on the layer of the second material and the substrate immediately below, and then,
in a sixth step subjecting the lenticular particles to a pulsed laser flux configured so that when the micro-focused energy attains an ablation threshold of the second and first materials, a cavity is formed in the second material and in the substrate at the location of a contact area of the lenticular particle while being accompanied by a rise of the second material forming a crown around the cavity pierced in the substrate.

16. The manufacturing method according to claim 14, wherein the deposition of a compact film of lenticular particles is achieved by a deposition technique comprised in the set consisting of a Langmuir-Blodgett, Langmuir-Schaefer technique and spin coating.

17. The manufacturing method according to claim 14, wherein
the lenticular particles are particles in a dielectric material comprised in the set formed by oxides, silica, quartz, polymers such as polystyrene or particles in an electrically conducting material comprised in the set consisting of gold, silver, stainless steel,
the lenticular particles have the shape of a sphere or of a sphere modified by a chemical etching, thermal etching, plasma etching process applied in an etching step performed between the third and fourth steps, or between the fifth and sixth steps, the diameter of the sphere being comprised between a few tens of nm and several tens of microns.

18. The manufacturing method according to claim 14, wherein the laser beam applied on the film of particles is collimated and delivered by pulses ranging from one femto-second to one nanosecond, preferably ranging from one femto-second to one picosecond.

19. The manufacturing method according to claim 14, comprising a step for cleaning residual lenticular particles performed after the second step.

20. The manufacturing method according to claim 13, comprising a step for depositing a second mono- or multi-layer material, performed after the second step or the cleaning step.
